(19) United States
(12) Patent Application Publication
(10) Pub. No.: US 2017/0082076 A1
(43) Pub. Date: Mar. 23, 2017

(54) PRESSURE REGULATOR FOR FUEL SUPPLY SYSTEM

(71) Applicant: Caterpillar Inc., Peoria, IL (US)

(72) Inventor: Xinyu Ge, Peoria, IL (US)

(73) Assignee: CATERPILLAR INC., Peoria, IL (US)

(21) Appl. No.: 14/856,603

(22) Filed: Sep. 17, 2015

(51) Int. Cl. F02M 37/00

(52) U.S. Cl. CPC F02M 37/0052

(57) ABSTRACT

A pressure regulator including an inlet port for receiving a fuel supply, a first outlet port in fluid communication with a main combustion chamber and a second outlet port in fluid communication with a pre-combustion chamber in an engine is provided. A first valve is located within the first outlet port and a first actuator is configured to operate the first valve to regulate a fuel supply through the first outlet port to the main combustion chamber. A second valve is located within the second outlet port and a second actuator is configured to operate the second valve to control a fuel supply through the second outlet port to the pre-combustion chamber.

### TECHNICAL FIELD

The present disclosure relates generally to a system and a method for regulating fuel supply to an engine, and more particularly relates to a pressure regulator for regulating fuel supply to a main combustion chamber and a pre-combustion chamber in the engine.

### BACKGROUND

Natural gas is attractive as a low cost, clean burning alternative to conventional fuels commonly used in diesel engines. With stringent emission regulations, more natural gas engines are being utilized to supply power to stationary or mobile applications. Compressed Natural Gas (CNG), as a fuel, is generally stored in a tank under high pressure, for example, 250-350 bars. Such high pressure is not generally compatible with the operation of an internal combustion engine. Accordingly, the pressure of the gaseous fuel needs to be reduced to a level acceptable for introduction into the engine. Further, for engines using indirect injection, it may sometimes be required that a main combustion chamber and a pre-combustion chamber of the engine receive the gaseous fuel at different pressures.

US Patent Publication Number 2013/0333671 ('671 reference) describes methods and systems for accurate and precise fuel supply control for continuous-flow of gaseous fuel to an internal combustion engine. The system includes a dual-stage valve that allows optimal control, a first stage in the form of a voice-coil driven electronic pressure regulator, and a second stage in the form of a voice-coil-driven choked-flow valve. The method includes monitoring the pressure of the fuel intermediate the two stages and making appropriate adjustments to the first stage via a pressure actuator loop; feeding the gaseous fuel mixture through a unitary block assembly into the second stage; monitoring the pressure of the air/fuel mixture and making appropriate adjustments to the second stage via a valve actuator control loop.

The '671 reference may provide dual-stage pressure regulation for more accurate control over the pressure of fuel supply to the engine, however the disclosed methods and systems may not be applicable for independently regulating the pressure of fuel supply to both the main combustion chamber and the pre-combustion chamber of the engine, for example, in engines utilizing indirect injection.

### SUMMARY OF THE DISCLOSURE

In one aspect of the present disclosure, a pressure regulator for an engine is provided. The pressure regulator includes an inlet port configured to receive a fuel supply. The pressure regulator also includes a first outlet port located downstream of the inlet port and in fluid communication with a main combustion chamber in the engine. A first valve is located within the first outlet port and a first actuator is configured to operate the first valve to regulate a fuel supply through the first outlet port to the main combustion chamber. The pressure regulator also includes a second outlet port located downstream of the inlet port and upstream of the first outlet port, and in fluid communication with a pre-combustion chamber in the engine. A second valve is located within the second outlet port and a second actuator is configured to operate the second valve to control a fuel supply through the second outlet port to the pre-combustion chamber.

In another aspect of the present disclosure, a method of regulating fuel supply to an engine is provided. The method includes receiving a fuel supply in a body of a pressure regulator via an inlet port. The method also includes regulating a fuel supply through a first outlet port to a main combustion chamber of the engine via a first valve. The method further includes controlling a fuel supply through a second outlet port to a pre-combustion chamber of the engine via a second valve.

In yet another aspect of the present disclosure, an engine having a main combustion chamber and a pre-combustion chamber is provided. The engine includes a pressure regulator having a body and a controller. The body provides an inlet port configured to receive a fuel supply. The body also provides a first outlet port located downstream of the inlet port and in fluid communication with a main combustion chamber in the engine. A first valve is located within the first outlet port and a first actuator is configured to operate the first valve to regulate a fuel supply through the first outlet port to the main combustion chamber. The body further provides a second outlet port located downstream of the inlet port and upstream of the first outlet port, and in fluid communication with a pre-combustion chamber in the engine. A second valve is located within the second outlet port and a second actuator is configured to operate the second valve to control a fuel supply through the second outlet port to the pre-combustion chamber. The controller is configured to control the first actuator for operating the first valve. The engine further includes a control module configured to control the second actuator for operating the second valve.

Other features and aspects of this disclosure will be apparent from the following description and the accompanying drawings.

### BRIEF DESCRIPTION OF THE DRAWINGS

FIG. 1 is a schematic illustration of a fuel supply system in association with an engine, in accordance with an embodiment of the present disclosure;

FIG. 2 is a schematic illustration of a pressure regulator in association with an Engine Control Unit, in accordance with an embodiment of the present disclosure;

FIG. 3 is a representative sectional view of the pressure regulator, in accordance with an embodiment of the present disclosure; and

FIG. 4 is a flowchart of a method for regulating fuel supply to the engine, in accordance with an embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

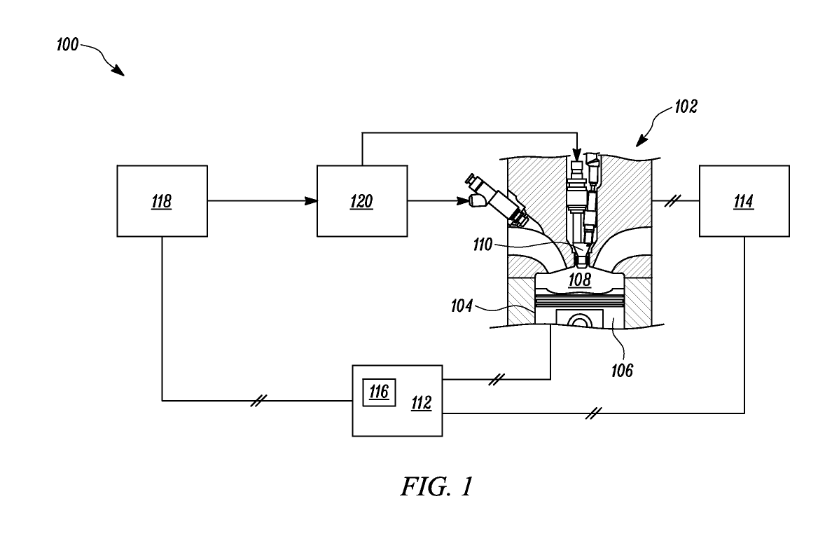

FIG. 1 illustrates a schematic representation of a fuel supply system 100 to deliver a fuel supply to an engine 102, in accordance with an embodiment of the present disclosure. The engine 102 may be an internal combustion engine, such as, a reciprocating piston engine. The engine 102 may be a spark ignition engine or a compression ignition engine, such as, a homogeneous charge compression ignition engine, or a reactivity controlled compression ignition engine, or other compression ignition engines known in the art. The engine 102 may use a gaseous fuel as a primary fuel, such as, compressed natural gas (CNG), liquefied petroleum gas (LPG), hydrogen or combinations thereof, or any other gaseous combustion fuel known in the art.

The engine 102 may be used to provide power to any machine including, but not limited to, an on-highway truck, an off-highway truck, an earth moving machine, an electric generator, and so on. Further, the engine 102 may be associated with any industry including, but not limited to, transportation, construction, agriculture, forestry, power generation, and material handling. The engine 102 may include components, such as, a fuel system, an intake system, a drivetrain including a transmission system, etc. as are conventionally known in the art and therefore have not been described in further detail for the brevity of the disclosure.

The engine 102 may include a cylinder 104, and a piston 106 located in the cylinder 104, such that the movement of the piston 106 defines a main combustion chamber 108 in the cylinder 104 of the engine 102. In an embodiment, the engine 102 also includes a pre-combustion chamber 110. The main combustion chamber 108 may be in fluid communication with the pre-combustion chamber 110 via a channel or a nozzle (not shown). The pre-combustion chamber 110 may be disposed such that partially combusted products from the pre-combustion chamber 110 are forced through the channel or the nozzle to the main combustion chamber 108 in which a gaseous fuel mixture is ignited by the partially combusted products, a process known as indirect injection. In some operating conditions, the gaseous fuel mixture in the main combustion chamber 108 may be ignited by a spark plug (not illustrated) inside of the main combustion chamber 108 and no fuel may be supplied to the pre-combustion chamber 110 to facilitate the combustion in the main combustion chamber 108. It may be understood that the cylinder 104, the piston 106, and the main combustion chamber 108 and the pre-combustion chamber 110 of the engine 102 are illustrated in a schematic manner in FIG. 1 only to show the relative relationships with the other components of the fuel supply system 100.

The engine 102 may be operatively coupled in signal communication with an engine control unit (ECU) 112. The ECU 112, in turn, may be operatively coupled in signal communication with a sensor unit 114 associated with the engine 102. The sensor unit 114 may include a number of sensors coupled to the engine 102, either locally or remotely, for providing signals as a function of operating parameters of the engine 102. For example, the sensor unit 114 may be responsive to engine speed, engine temperature, manifold air pressure, air temperature to generate signals and for feeding corresponding signals to the ECU 112. The ECU 112, in conjunction with the sensor unit 114, may be configured to monitor the operating parameters of the engine 102. It may be contemplated that the various connections, such as, between the engine 102 and the ECU 112, and the ECU 112 and the sensor unit 114 are provided by communication lines. The communication lines have been represented in the drawings as connection lines with an inclined double dash. The communication lines may include one or more of commonly used data buses, fiber optic cables, embedded connections or the like.

It may be understood that the ECU 112 may be a logic unit using any one or more of a processor, a microprocessor, a microcontroller, or any other suitable means. The ECU 112 may be based on integrated circuitry, discrete components, or a combination of the two. It will be appreciated that other peripheral circuitry such as buffers, latches, switches and so on may be implemented within the ECU 112 or separately as desired.

The ECU 112 may be responsive to the signals from the sensor unit 114 to control the various operating parameters of the engine 102. In an embodiment, the ECU 112 may include a control module 116. The control module 116 may be defined as one or more algorithms stored in a memory (not shown) of the ECU 112, and having a set of instructions to be executed by the ECU 112. In an embodiment, the control module 116 may configure the ECU 112 to determine pressure of fuel required for operation of the engine 102. The pressure of fuel or other parameters may be determined, for example, by referencing fuel supply maps stored in the memory as a function of the signals from the sensor unit 114.

In an embodiment, the control module 116 may further configure the ECU 112 to control the pressure of fuel supply to the engine 102. Specifically, the control module 116 may configure the ECU 112 to independently control the pressures of fuel supplies to both the main combustion chamber 108 and the pre-combustion chamber 110 of the engine 102. For this purpose, the control module 116 may configure the ECU 112 to first determine the pressures of the fuel supply required for the main combustion chamber 108 and the pre-combustion chamber 110 based on the signal received from the sensor unit 114, as described above. Such methods and processes are applicable for engines implementing lean burn strategy in which the pre-combustion chamber 110 is usually supplied with fuel at higher pressure than the main combustion chamber 108. The fuel supply maps and algorithms for such calculations are known in the art and have not been described herein for the brevity of the disclosure.

Further, as illustrated in FIG. 1, the fuel supply system 100 may also include a fuel supply tank 118 configured to store the fuel for the engine 102. The fuel supply tank 118 may be configured to store the fuel, such as, but not limited to, compressed natural gas (CNG) or the like. Since the fuel, in the form of the gas, is typically stored at a high pressure, the fuel supply tank 118 may be adapted to withstand such high pressures.

In an embodiment, the fuel supply system 100 includes a pressure regulator 120 in fluid communication with the fuel supply tank 118 and the engine 102. The pressure regulator 120 may be configured to regulate the pressure of fuel supply from the fuel supply tank 118 to the engine 102. In particular, the pressure regulator 120 may be configured to independently regulate the pressures of fuel supply for both the main combustion chamber 108 and the pre-combustion chamber 110 of the engine 102.

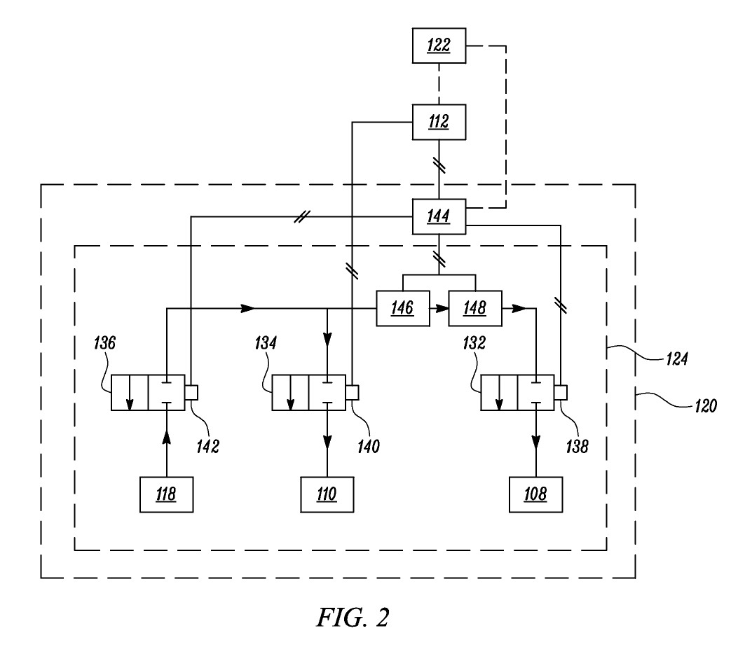

FIG. 2 is a schematic view of the pressure regulator 120 disposed in connections with components of the fuel supply system 100, the ECU 112 and a power source 122. The power source 122 may include a battery to power the various components of the pressure regulator 120 and the ECU 112. The power source 122 may be connected to the ECU 112 by electrical lines, representatively shown as dash-dot lines. In one example, the power source 122 may further power various other components of the fuel supply system 100, such as, the sensor unit 114.

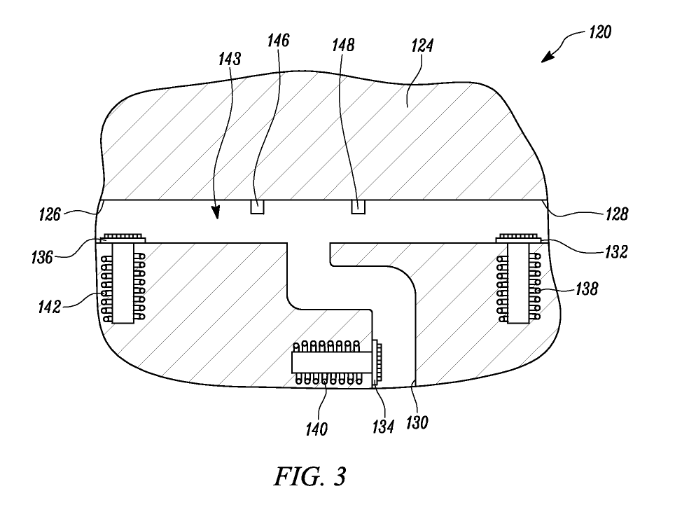

In an embodiment, as illustrated in FIG. 3, the pressure regulator 120 may include a body 124 in the form of a block to support the various elements therein. As illustrated, the body 124 provides an inlet port 126 for receiving the fuel supply from the fuel supply tank 118 to an inside of the body 124 of the pressure regulator 120. For this purpose, the inlet port 126 may be in fluid communication with the fuel supply tank 118 via a conduit (not shown). The body 124 further provides a first outlet port 128 and a second outlet port 130 for the pressure regulator 120. As illustrated, the first outlet port 128 may be located downstream of the inlet port 126 in the body 124. The first outlet port 128 may be in fluid communication with the main combustion chamber 108 of the engine 102 via another conduit (not shown). Further, as illustrated in FIG. 2, the second outlet port 130 may be located downstream of the inlet port 126 and upstream of the first outlet port 128 in the body 124. The second outlet port 130 may be in fluid communication with the pre-combustion chamber 110 of the engine 102 via yet another conduit (not shown). It may be understood that the conduits may be in the form of a pipe, a tube or the like.

The pressure regulator 120 may include a combination of valves, i.e., a first valve 132, a second valve 134, and a third valve 136. In one example, the first valve 132, the second valve 134, and the third valve 136 are provided within the body 124 of the pressure regulator 120. In other example, some portions of one or more of the first valve 132, the second valve 134, and the third valve 136 may be extending outside of the body 124 of the pressure regulator 120.

Referring to FIGS. 2-3, the first valve 132 may be located within the first outlet port 128. The first valve 132 may be disposed with respect to the first outlet port 128 in order to control fluid communication between the inside of the body 124 of the pressure regulator 120 and the main combustion chamber 108. The first valve 132 may be one of a poppet valve, a butterfly valve, or a globe valve. In an embodiment, the first valve 132 may be a proportional valve, that is, the first valve 132 may be discretely or incrementally controlled in order to regulate the pressure of the fuel from the inside of the body 124 to the main combustion chamber 108. For this purpose, the pressure regulator 120 may also include a first actuator 138 associated with the first valve 132. In one example, the first actuator 138 may be a proportional controlled solenoid. In an alternate example, the first actuator 138 may be a torque motor. The first actuator 138 may be configured to operate, in other words incrementally control the opening and closing of, the first valve 132 to regulate the pressure of the fuel supply through the first outlet port 128 to the main combustion chamber 108.

The second valve 134 may be located within the second outlet port 130. The second valve 134 may be disposed with respect to the second outlet port 130 in order to control fluid communication between the inside of the body 124 and the pre-combustion chamber 110. In an embodiment, the second valve 134 may be a switch valve, such as a poppet valve or the like. The second valve 134 may be operated to either allow or stop the fuel supply from the inside of the body 124 to the pre-combustion chamber 110. The pressure regulator 120 may include a second actuator 140 associated with the second valve 134. The second actuator 140 may be configured to operate the second valve 134 by controlling the opening and closing of the second valve 134, and thereby control the fuel supply through the second outlet port 130 to the pre-combustion chamber 110.

In an alternate embodiment, the second valve 134 may be a two-position, 3-way valve. In a first position, the second valve 134 may connect the inside of the body 124 of the pressure regulator 120 in fluid communication with the pre-combustion chamber 110, and thus control the fuel supply to the pre-combustion chamber 110, as discussed above. In a second position, the second valve 134 may connect an ambient air source in fluid communication with the pre-combustion chamber 110 in order to relieve any possible vacuum condition formed inside the pre-combustion chamber 110 during the operation of the engine 102, such as when the pre-combustion chamber 110 is not in fluid communication with the inside of the body 124 of the pressure regulator 120.

The third valve 136 may be located within the inlet port 126. The third valve 136 may be disposed with respect to the inlet port 126 in order to control fluid communication between the fuel supply tank 118 and the inside of the body 124. The third valve 136 may be one of a poppet valve, a butterfly valve, or a globe valve. In an embodiment, the third valve 136 may be a proportional valve, that is, the third valve 136 may be discretely or incrementally controlled in order to regulate the pressure of the fuel received from the fuel supply tank 118 to the inside of the body 124. For this purpose, the pressure regulator 120 may include a third actuator 142 associated with the third valve 136. In one example, the third actuator 142 may be a proportional controlled solenoid. In an alternate example, the third actuator 142 may be a torque motor. The third actuator 142 may be configured to operate, in other words incrementally control the opening and closing of, the third valve 136 to regulate the pressure of the fuel supply through the inlet port 126 to the inside of the body 124.

As illustrated in FIG. 3, a flow path 143 is defined in the body 124 of the pressure regulator 120. It may be seen that the flow path 143 may run from the inlet port 126 to the first outlet port 128 extending along the length of the body 124, and further branch out to connect the second outlet port 130 with the inlet port 126 and the first outlet port 128. The shape of the flow path 143 illustrated in FIG. 3 is for exemplary purposes only, and may vary based on the requirement and type of the pressure regulator 120.

In an embodiment, the pressure regulator 120 further includes a controller 144 configured to monitor the conditions in the body 124 of the pressure regulator 120. For this purpose, the pressure regulator 120 may include one or more transducers disposed in signal communication with the controller 144. In an embodiment, the pressure regulator 120 may include a pressure transducer 146 and a temperature transducer 148. The pressure transducer 146 and the temperature transducer 148 may be located inside the body 124, downstream of the inlet port 126 and upstream of the first outlet port 128. The pressure transducer 146 and the temperature transducer 148 may provide signals being a direct function of a pressure and a temperature of the fuel inside the body 124 of the pressure regulator 120. The controller 144 may be configured to process these signals to determine the conditions inside the body 124. For example, the pressure reading in conjunction with the temperature reading may be used by the controller 144 to calculate flow rate of the fuel at the second outlet port 130 of the pressure regulator 120. This type of calculation uses basic principles and is well known to those skilled in the art.

As illustrated in FIG. 2, the controller 144 may be disposed in signal communication with the ECU 112 via the communication lines, as shown. The controller 144 may further be in electrical connection with the power source 122 to derive power for the operation by the electrical lines. In an embodiment, as have been schematically represented in FIG. 2, the controller 144 may be located remotely or separately of the body 124, in the pressure regulator 120. Also the controller 144 may be disposed in signal communication with the first actuator 138 and the third actuator 142, and further with the pressure transducer 146 and the temperature transducer 148 by the communication lines.

In an embodiment, the controller 144 may be configured to control the third actuator 142 in the pressure regulator 120. In this manner, the controller 144 may regulate the pressure of the fuel flowing through the third valve 136, and therefore regulate the pressure of fuel received from the fuel supply tank 118 to the inside of the body 124 of the pressure regulator 120. Generally, the controller 144 may control the third actuator 142 to reduce the pressure of the fuel flowing to the inside of the body 124 by reducing the flow rate of the fuel at the third valve 136. Since the fuel from the inside of the body 124 is supplied to the pre-combustion chamber 110, via the second valve 134, without any regulation, it may be understood that by regulating the pressure of the fuel at the inlet port 126, the controller 144 indirectly regulates the pressure of the fuel being supplied to the pre-combustion chamber 110.

Similarly, the controller 144 is further configured to control the first actuator 138 in the pressure regulator 120. In this manner, the controller 144 may regulate the pressure of the fuel supply through the first valve 132, and therefore regulate the pressure of fuel supply from the inside of the body 124 to the main combustion chamber 108 of the engine 102. The controller 144 may use the pressure and temperature readings from the pressure transducer 146 and the temperature transducer 148 to determine the existing pressure of the fuel inside the body 124. The controller 144 may accordingly control the first actuator 138 to bring the pressure of the fuel to the required level, typically reducing the pressure of the fuel, to be supplied to the main combustion chamber 108, via the first valve 132.

In an embodiment, the second actuator 140 may be controlled by the ECU 112. Depending on a condition of the engine 102, as determined from the signals from the sensor unit 114, and the condition of the pressure regulator 120 received via the controller 144, the control module 116 may configure the ECU 112 to control the fuel supply to the pre-combustion chamber 110. For example, in the indirect injection mode, the fuel supply to the pre-combustion chamber 110 is required to initiate the combustion in the main combustion chamber 108. In such case, the control module 116 may configure the ECU 112 to control the second actuator 140 to open or close the second valve 134. When the second valve 134 is opened, the fuel from the inside of the body 124 is supplied to the pre-combustion chamber 110. When the fuel mixture in the main combustion chamber 108 is ignited without the facilitation of the combustion in the pre-combustion chamber 110 (e.g. by the spark plug inside of the main combustion chamber 108), the second valve 134 is closed, and the fuel supply to the pre-combustion chamber 110 is stopped.

### INDUSTRIAL APPLICABILITY

For engines using the gaseous fuel, the Air-Fuel Ratio (AFR) is a critical parameter. The pressure of the fuel supplied to the engine directly impacts the AFR in the chambers of the engine. Therefore it may be important to precisely control the pressure of the fuel supplied to the engine. However, since the engines may be used for different applications, the pressure of the fuel supply may change dramatically from one application to another. Typical mechanical pressure regulators can only operate in a certain limited range due to the pressure droop. Further because of pulsating flow of fuel in the engine, the mechanical regulator may also be sensitive to resonance.

Further, in an indirect injection engine which utilizes a lean burn strategy, the pressure of fuel supply required for a pre-combustion chamber may be different from the pressure of fuel supply for the main combustion chamber. Typically, the pressure of fuel supplied to the pre-combustion chamber may be higher than the pressure of the fuel supplied to the main combustion chamber. With the same fuel supply tank, it may not be cost effective to use two separate pressure regulators to ensure desired AFR in both the pre-combustion chamber and the main combustion chamber.

The present disclosure describes a pressure regulator 120 which provides dual-stage pressure regulation, first at the inlet port 126 and second at the first outlet port 128, for precise regulation of the pressure of the fuel supply to the engine 102. Further, the pressure regulator 120 of the present disclosure may independently control the pressure of fuel supply to both the main combustion chamber 108 and the pre-combustion chamber 110. The pressure regulator 120 may provide or stop fuel supply to the pre-combustion chamber 110.

The pressure regulator 120 of the present disclosure may be able to adapt to the changing applications of the engine 102, for example, when the engine 102 is switched from implementing stoichiometric strategy to lean-burn strategy for combustion. It may be understood that under the stoichiometric combustion strategy, the fuel and air mixture with AFR close to stoichiometric value is ignited by the spark plug inside the main combustion chamber 108 without the facilitation of the combustion in the pre-combustion chamber 110; while under the lean-burn strategy, the fuel and air mixture in the main combustion chamber 108 is ignited by the partially combusted products from the pre-combustion chamber 110. With the pressure regulator 120 of the present disclosure, there may not be a need of any major modifications required to the ECU 112 for switching between the two strategies as such functionalities are taken care of by the controller 144 of the present pressure regulator 120.

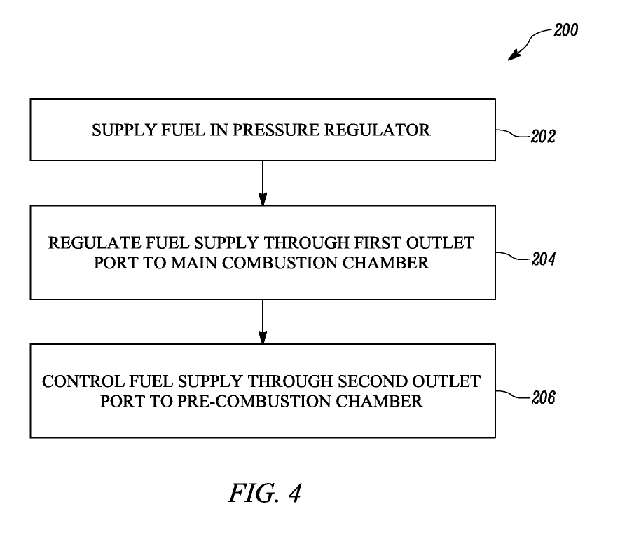

FIG. 4 diagrammatically illustrates a method 200 for regulating the fuel supply to the engine 102. In block 202, the method 200 includes supplying the fuel in the body 124 of the pressure regulator 120 via the inlet port 126. The fuel may be supplied to the pressure regulator 120 from the fuel supply tank 118. The fuel supply to the pressure regulator 120 may be regulated by the controller 144 by controlling the third actuator 142 which in turn operates the third valve 136 located within the inlet port 126.

In block 204, the method 200 includes regulating the fuel supply through the first outlet port 128 to the main combustion chamber 108 of the engine 102 via the first valve 132. The fuel supply to the main combustion chamber 108 may be regulated by the controller 144 by controlling the first actuator 138 operating the first valve 132 located within the first outlet port 128. In block 206, the method 200 further includes controlling the fuel supply through the second outlet port 130 to the pre-combustion chamber 110 via the second valve 134. The fuel supply to the pre-combustion chamber 110 may be controlled by the ECU 112 by controlling the second actuator 140 operating the second valve 134 located within the second outlet port 130.

While aspects of the present disclosure have been particularly shown and described above, it will be understood by those skilled in the art that various additional aspects may be contemplated by the modification of the disclosed systems and methods without departing from the spirit and scope of what is disclosed. Such aspects should be understood to fall within the scope of the present disclosure as determined based upon the claims and any equivalents thereof.

What is claimed is:

1. A pressure regulator for an engine, comprising:
an inlet port configured to receive a fuel supply therethrough;
a first outlet port located downstream of the inlet port and in fluid communication with a main combustion chamber in the engine;
a first valve located within the first outlet port;
a first actuator configured to operate the first valve to regulate a fuel supply through the first outlet port to the main combustion chamber;
a second outlet port located downstream of the inlet port and upstream of the first outlet port, and in fluid communication with a pre-combustion chamber in the engine;
a second valve located within the second outlet port; and
a second actuator configured to operate the second valve to control a fuel supply through the second outlet port to the pre-combustion chamber.

2. The pressure regulator of claim 1, further comprising a third valve located within the inlet port and a third actuator configured to operate the third valve to regulate the fuel supply through the inlet port.

3. The pressure regulator of claim 1, wherein the first valve comprises at least one of a poppet valve, a butterfly valve, or a globe valve.

4. The pressure regulator of claim 1, wherein the second valve comprises a switch valve.

5. The pressure regulator of claim 1, wherein the second valve comprises a 3-way valve.

6. The pressure regulator of claim 2, wherein each of the first actuator, the second actuator and the third actuator comprise independently one of a solenoid actuator or a torque motor actuator.

7. The pressure regulator of claim 2, wherein the first actuator and the third actuator comprise proportional control actuators.

8. The pressure regulator of claim 1, further comprising a body, wherein the inlet port, the first outlet port and the second outlet port are located in the body, and wherein the pressure regulator comprises a controller disposed remotely of the body.

9. The pressure regulator of claim 8, wherein the controller is configured to control the first actuator for operating the first valve.

10. The pressure regulator of claim 1, wherein the second actuator is controlled by a control module of the engine.

11. A method of regulating a fuel supply to an engine, the method comprising:
receiving a fuel supply in a body of a pressure regulator via an inlet port located therein;
regulating a fuel supply through a first outlet port to a main combustion chamber of the engine via a first valve, the first outlet port being located in the body; and
controlling a fuel supply through a second outlet port to a pre-combustion chamber of the engine via a second valve, the second outlet port being located in the body.

12. The method of claim 11 further comprising, regulating the fuel supply through the inlet port to the body via a third valve.

13. The method of claim 12, wherein the first valve and the third valve are controlled independently by a controller.

14. The method of claim 11, wherein the second valve is controlled by a control module of the engine.

15. An engine comprising:
a main combustion chamber and a pre-combustion chamber;
a pressure regulator comprising:
a body comprising:
an inlet port configured to receive a fuel supply therethrough;
a first outlet port located downstream of the inlet port and in fluid communication with the main combustion chamber;
a first valve located within the first outlet port;
a first actuator configured to operate the first valve to regulate a fuel supply through the first outlet port to the main combustion chamber;
a second outlet port located downstream of the inlet port and upstream of the first outlet port, and in fluid communication with the pre-combustion chamber;
a second valve located within the second outlet port; and
a second actuator configured to operate the second valve to control a fuel supply through the second outlet port to the pre-combustion chamber; and
a controller configured to control the first actuator for operating the first valve; and
a control module configured to control the second actuator for operating the second valve.

16. The engine of claim 15, wherein the pressure regulator further comprises a third valve located within the inlet port and a third actuator configured to operate the third valve to regulate the fuel supply through the inlet port.

17. The engine of claim 16, wherein the controller is further configured to control the third actuator for operating the third valve.

18. The engine of claim 15, wherein the controller is disposed remotely of the body in the pressure regulator.

19. The engine of claim 15, wherein the first valve comprises at least a poppet valve, and the second valve comprises at least one of a switch valve or a 3-way valve.

20. The engine of claim 15, wherein the pressure regulator further comprises a pressure transducer and a temperature transducer located upstream of the first outlet port and downstream of the second outlet port, the pressure transducer and the temperature transducer disposed in communication with the controller.
